(19) United States
(12) Patent Application Publication
(10) Pub. No.: US 2014/0003076 A1
(43) Pub. Date: Jan. 2, 2014

(54) VEHICULAR LAMP AND WINDOW UNIT

(71) Applicant: Koito Manufacturing CO., LTD., Tokyo (JP)

(72) Inventors: Shinya Suganumata, Shizuoka (JP); Yasuo Teranishi, Shizuoka (JP); Kenichi Motomura, Shizuoka (JP); Asami Nakada, Shizuoka (JP); Kenji Yamada, Shizuoka (JP); Tsukasa Tokida, Shizuoka (JP)

(21) Appl. No.: 13/930,995

(22) Filed: Jun. 28, 2013

(30) Foreign Application Priority Data
Jun. 29, 2012 (JP) 2012-146194

(51) Int. Cl. B60Q 1/30

(52) U.S. Cl. CPC B60Q 1/30
USPC 362/511

(57) ABSTRACT

A vehicular lamp that is mounted on a vehicle has a light source, a transparent part that is transparent when viewed from inside of a compartment when mounted on the vehicle, a light guiding member that forms at least a part of the transparent part, wherein the light guide member is configured to guide light emitted from the light source toward outside of the compartment when mounted on the vehicle, and a light-shielding member that blocks the light emitted from the light source and that travels toward the inside of the compartment when mounted on the vehicle.

### BACKGROUND OF THE DISCLOSURE

1. Field of the Invention

The present invention relates to lamps that are mounted on vehicles, and window units provided on vehicles.

2. Description of the Related Art

A configuration of a window unit is known in which the window unit is formed by integrally mounting a rear combination lamp as a vehicular lamp on a window member (rear windshield) forming a part of a back door that is provided in the rear part of a vehicle and that can be opened and closed (see, e.g., Patent Document 1).

[Patent Document 1]
Japanese Patent Application Laid-Open (Kokai) No. H06-150704

### SUMMARY

In the above configuration, since a part of the window member is covered by the rear combination lamp mounted thereon, it cannot be avoided that the visible region behind the vehicle is reduced.

One or more embodiments of the present invention provides a technique of placing a lamp so as to cover a part of a window member while not hindering rear visibility.

According to a first aspect of the present invention, a lamp that is mounted on a vehicle includes: a light source; a transparent part that is transparent as viewed from inside of a compartment when mounted on the vehicle; a light guiding member that forms at least a part of the transparent part, and is configured to guide light emitted from the light source toward outside of the compartment when mounted on the vehicle; and a light-shielding member that blocks the light emitted from the light source and traveling toward the inside of the compartment when mounted on the vehicle.

According to a second aspect of the present invention, a window unit that is provided on a vehicle includes: a window member; a light source; a transparent part that is transparent as viewed from inside of the window member; a light guiding member that forms at least a part of the transparent part, and is configured to guide light emitted from the light source toward outside of the window member; and a light-shielding member that blocks the light emitted from the light source and traveling toward the inside of the window member.

According to the above configuration, the lamp includes the transparent portion that allows an occupant to see the outside of the vehicle from the inside of the compartment. This can ensure outside visibility of the vehicle although the lamp is mounted so as to cover a part of the window member. Since the light emitted from the light source and traveling toward the inside of the compartment is blocked by the light-shielding member, the light is not allowed to be in the driver's sight when the light source is lit, whereby his/her driving operation can be prevented from being hindered by such light.

In particular, in the case where the lamp according to one or more of the present invention is used as a tail/stop lamp, red light that is emitted from the light source when the light source is lit need be prevented from being visually recognized from the front of the vehicle. The red light is recognized as being visually recognized only from behind the vehicle. Therefore, if the red light reaches the front of the vehicle, those who are around the vehicle may wrongly recognize the front of the vehicle as the rear of the vehicle. The above configuration can avoid such a situation.

The at least a part of the transparent part may have characteristics that selectively absorb light having an emission wavelength of the light source.

Since light emitted from the light source is internally reflected by the light guiding member, leakage light may be caused at an unexpected location. The above configuration can reliably block such leakage light by the transparent part. This can avoid the disadvantage that is caused by the red light leaking to the front of the vehicle. Since the area of the light-shielding member need not be increased to prevent leakage light, rear (outside) visibility of the vehicle is not hindered.

In the case where the at least a part of the transparent part and the light-shielding member are molded integrally, the number of parts can be reduced. As used herein, the expression “integrally mold” refers to an integral, indivisible (monolithic) state obtained by, e.g., two-color molding etc. In this specification, this expression is used as meaning that distinguishes this configuration from the configuration in which independent members are unified by bonding or welding.

The light-shielding member may be formed on the light guiding member by evaporation. This can reduce the number of parts, and can implement reduction in size of the structure.

The light guiding member may be molded integrally with the window member. This can also reduce the number of parts, and can implement reduction in size of the structure.

The window unit may further include an opaque frame member provided on a peripheral edge of the window member, and a part of the light-shielding member may be formed by the frame member. This can also reduce the number of parts, and can implement reduction in size of the structure.

### BRIEF DESCRIPTION OF THE DRAWINGS

FIG. 1 is a perspective view schematically showing the appearance of the rear part of a vehicle on which a lamp according to one or more embodiments of the present invention is mounted.

FIGS. 2(a)-2(b) show diagrams schematically showing the configuration of a lamp according to a first embodiment of the present invention.

FIGS. 3(a)-3(b) show diagrams schematically showing modifications of the lamp of FIGS. 2(a)-2(b).

FIGS. 4(a)-4(b) show diagrams schematically showing the configuration of a lamp according to a second embodiment of the present invention.

FIGS. 5(a)-5(b) show diagrams schematically showing modifications of the lamp of FIGS. 4(a)-4(b).

FIGS. 6(a)-6(b) show diagrams schematically showing the configuration of a lamp according to a third embodiment of the present invention.

FIGS. 7(a)-7(b) show diagrams schematically showing modifications of the lamp of FIGS. 6(a)-6(b).

FIGS. 8(a)-8(b) show diagrams schematically showing the configuration of a lamp according to a fourth embodiment of the present invention.

FIGS. 9(a)-9(b) show diagrams schematically showing modifications of the lamp of FIGS. 8(a)-8(b).

FIGS. 10(a)-10(c) show diagrams schematically showing modifications of the lamp of FIGS. 8(a)-8(b).

FIGS. 11(a)-11(b) show diagrams schematically showing the configuration of a lamp according to a fifth embodiment of the present invention.

FIGS. 12(a)-12(b) show diagrams schematically showing modifications of the lamp of FIGS. 10(a)-10(b).

FIGS. 13(a)-13(b) show diagrams schematically showing the configuration of a lamp according to a sixth embodiment of the present invention.

### DETAILED DESCRIPTION

Hereafter, embodiments of the present invention will be described in detail with reference to accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. In each drawing used in the following description, the scale of each member is modified as appropriate in order to make it recognizable.

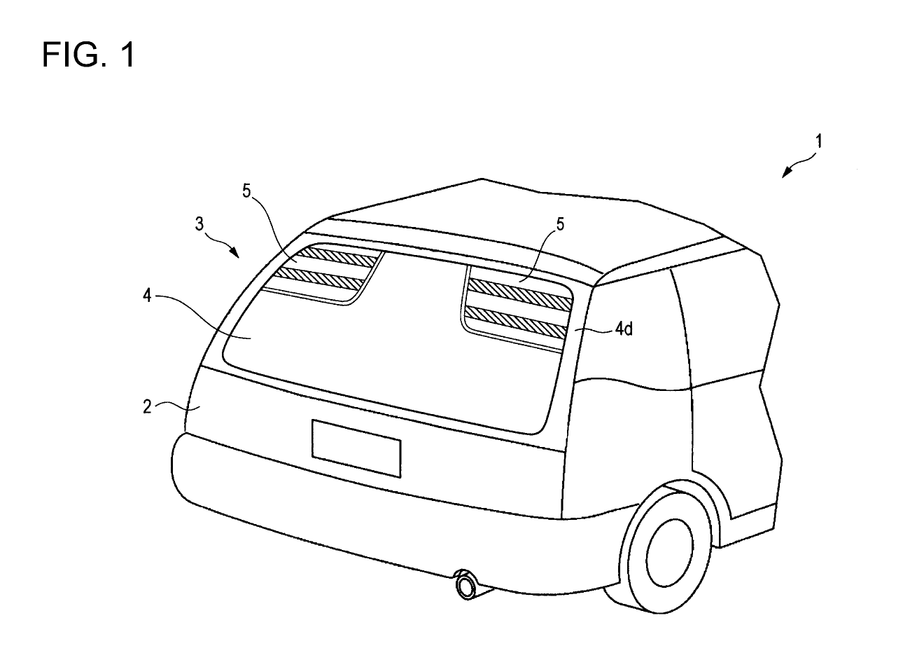

FIG. 1 is a perspective view schematically showing a rear part of a vehicle 1. A back door 2 that opens and closes a compartment space in the rear part of the vehicle is provided with a window unit 3 according to one or more embodiments of the present invention. The window unit 3 is configured so that a lamp 5 according to one or more embodiments of the present invention is mounted on a window member 4.

The window member 4 is a transparent member (so-called rear windshield) provided to allow an occupant to see rearward from the inside of the compartment, and is made of glass or resin. The lamp 5 forms a so-called rear combination lamp including a tail/stop lamp, a marker lamp, and a back-up lamp.

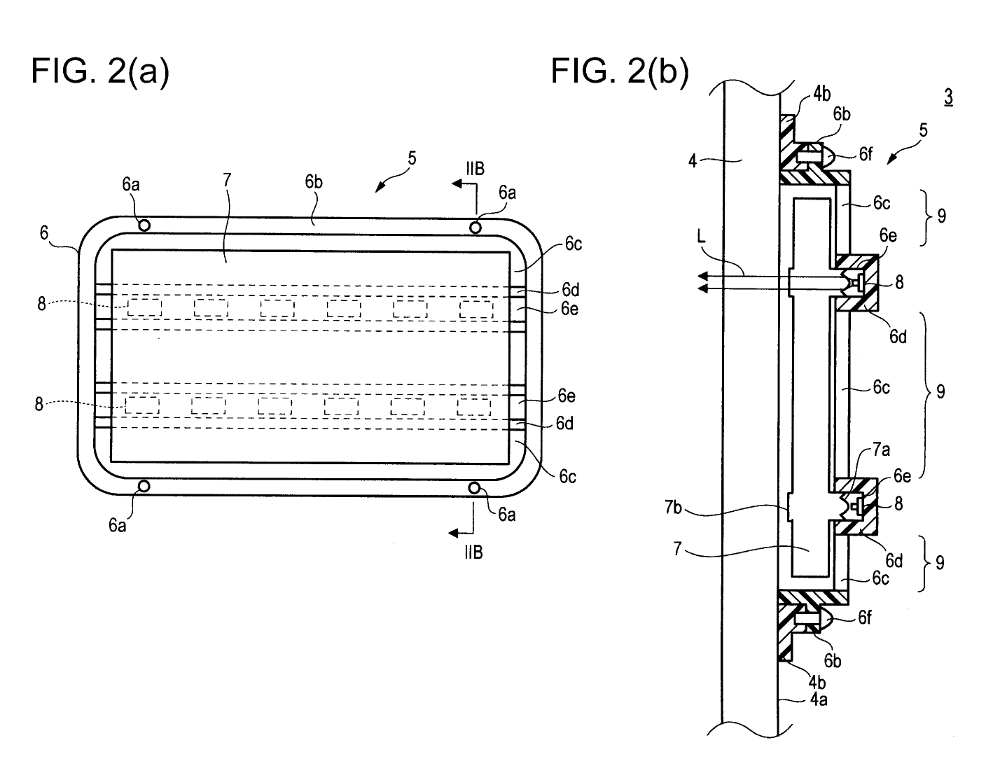

FIGS. 2(a)-2(b) schematically show the configuration of the lamp 5 according to a first embodiment of the present invention. FIG. 2(a) is a front view of the lamp 5 mounted on the vehicle as viewed from the rear, and FIG. 2(b) is a longitudinal sectional view taken along line IIB-IIB in FIG. 2(a). The lamp 5 includes a housing 6, a light guiding member 7, and a plurality of light-emitting diodes (LEDs) 8.

The housing 6 is a resin member that is formed by integrally molding an opaque frame portion 6b having holes 6a formed therein, a transparent portion 6c, and an opaque portion 6d by two-color molding etc. The opaque portion 6d is provided such that a groove 6e extending in the lateral direction of the vehicle 1 is formed at two positions in the vertical direction of the vehicle 1. The transparent portion 6c is formed in a portion located between the frame portion 6b and each opaque portion 6d.

The light guiding member 7 is a transparent plate-like member made of a resin such as polymethylmethacrylate or polycarbonate. A first lens portion 7a is formed on a surface of the light guiding member 7 which faces the inside of the compartment, and a second lens portion 7b is formed on a surface of the light guiding member 7 which faces the outside of the compartment. The first lens portion 7a and the second lens portion 7b are not shown in FIG. 2(a).

The plurality of LEDs 8 as the light source according to one or more embodiments of the present invention are arranged side-by-side in the lateral direction of the vehicle 1 in each groove 6e formed by each opaque portion 6d of the housing 6. For example, those LEDs 8 which are used as the tail/stop lamp emit red light, those LEDs 8 which are used as the marker lamp emit orange light, and those LEDs 8 which are used as the back-up lamp emit white light. The number of LEDs 8 and the arrangement thereof are determined as appropriate according to the specification of the vehicle 1 on which the LEDs 8 are to be mounted.

As shown in FIG. 2(b), the lamp 5 is mounted by fixing with screws 6f the frame portion 6b of the housing 6 to a support portion 4b provided on a surface 4a of the window member 4 which faces the inside of the compartment, thereby forming the window unit 3.

The light guiding member 7 is placed at a position closer to the outside of the compartment than the LEDs 8 in a space defined by the surface 4a of the window member 4 and the housing 6. At this time, a part of the first lens portion 7a is accommodated in the groove 6e formed in the opaque portion 6d of the housing 6. The first lens portion 7a and the second lens portion 7b of the light guiding member 7 are arranged side-by-side from the inside toward the outside of the compartment on an optical axis of each LED 8.

The first lens portion 7a of the light guiding member 7 has a well-known shape that can form incident light into parallel light fluxes. The second lens portion 7b of the light guiding member 7 has a well-known shape that can diffuse incident light in the lateral direction of the vehicle 1 to emit the diffused light. The light guiding member 7 is overall configured to guide light emitted from each LED 8 to the outside of the compartment.

Light L emitted from each LED 8 is formed into parallel light fluxes by the first lens portion 7a, travels inside the light guiding member 7, and passes through the second lens portion 7b, whereby the light L passes through the window member 4 while being diffused in the lateral direction of the vehicle 1. Thus, light is visually recognized as being emitted from near the opaque portions 6d of the housing 6 as viewed from behind the vehicle 1.

As shown in FIG. 2(b), a region where the transparent portion 6c of the housing 6 is formed is a transparent part 9 that allows the occupant to see rearward (outside) of the vehicle from the inside of the compartment through the light guiding portion 7 and a part of the window member 4. This can ensure rear (outside) visibility of the vehicle although the lamp 5 functioning as the rear combination lamp is mounted so as to cover a part of the window member 4.

The opaque portion 6d of the housing 6 functions as the light shielding member according to one or more embodiments of the present invention, and blocks light emitted from each LED 8 and traveling toward the inside of the compartment. This can ensure that rear (outside) visibility of the vehicle, and does not allow light of each LED 8 to be in the driver's sight when each LED 8 is lit, whereby his/her driving operation can be prevented from being hindered by such light.

In particular, the red light that is emitted from the LEDs 8 when lighting the tail/stop lamp need be prevented from being visually recognized from the front of the vehicle 1. The red light is recognized as being visually recognized only from behind the vehicle. Therefore, if the red light reaches the front of the vehicle, those who are around the vehicle may wrongly recognize the front of the vehicle 1 as the rear of the vehicle 1. The above configuration can avoid such a situation.

Since the transparent portion 6c functioning as a part of the transparent part and the opaque portion 6d functioning as the light-shielding member are molded integrally, the number of parts and the number of assembly steps can be reduced.

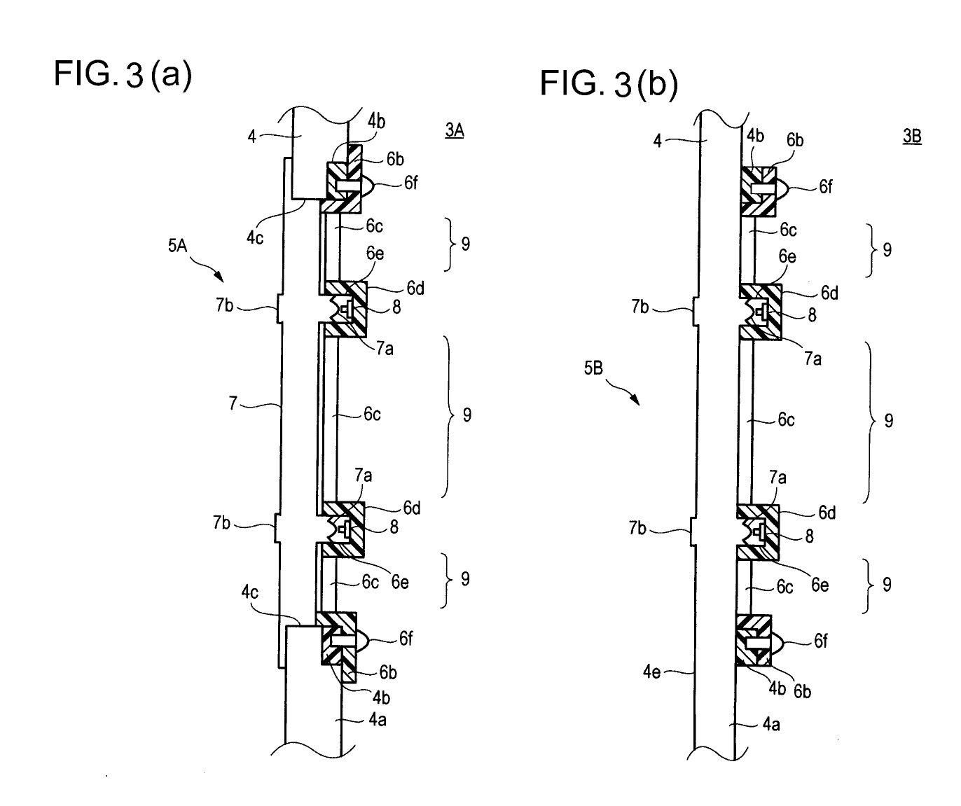

FIG. 3(a) is a longitudinal sectional view showing a first modification of the first embodiment. Those elements which have a similar function to the configuration shown in FIGS. 2(a)-2(b) are denoted with the same reference numerals, and repetitive description thereof will be omitted. A lamp 5A according to this modification is different from the lamp 5 and the window unit 3 shown in FIGS. 2(a)-2(b) in that a window unit 3A is formed by mounting the lamp 5A in an opening 4c formed in the window member 4. This configuration can reduce the dimensions of the lamp in the thickness direction.

FIG. 3(b) is a longitudinal sectional view showing a second modification of the first embodiment. Those elements which have a similar function to the configuration shown in FIGS. 2(a)-2(b) are denoted with the same reference numerals, and repetitive description thereof will be omitted. A lamp 5B according to this modification is different from the lamp 5 and the window unit 3 shown in FIGS. 2(a)-2(b) in that a window unit 3B is formed by using a part of the window member 4 as the light guiding member.

In this modification, the first lens member 7a is formed on a part of the surface 4a of the window member 4 which faces the inside of the compartment, and the second lens portion 7b is formed on a part of the surface 4e of the window member 4 which faces the outside of the compartment. The housing 6 is mounted on the window member 4 such that the first lens portion 7a is accommodated in the groove 6e formed in the opaque portion 6d. This configuration can reduce the number of parts, and can reduce the dimensions of the lamp in the thickness direction.

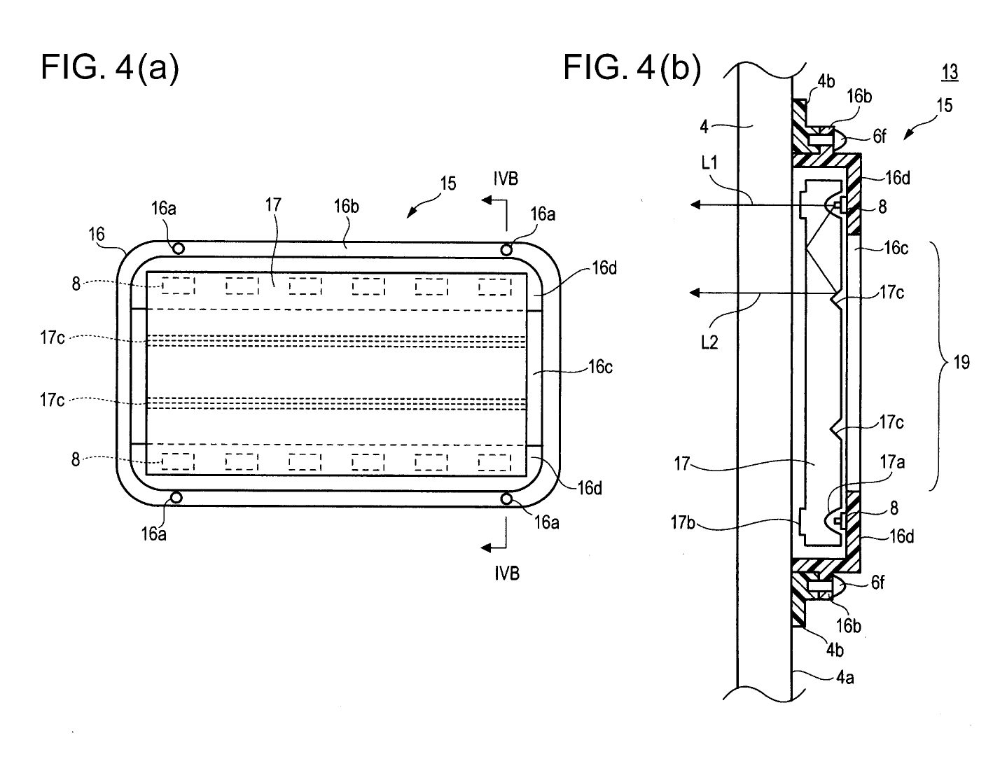

FIGS. 4(a)-4(b) schematically show the configuration of a lamp 15 according to a second embodiment of the present invention. FIG. 4(a) is a front view of the lamp 5 mounted on a vehicle as viewed from the rear, and FIG. 4(b) is a longitudinal sectional view taken along line IVB-IVB in FIG. 4(a). Those elements which have a similar function to the configuration shown in FIGS. 2(a)-2(b) are denoted with the same reference numerals, and repetitive description thereof will be omitted. The lamp 15 includes a housing 16, a light guiding member 17, and a plurality of LEDs 8.

The housing 16 is a resin member that is formed by integrally molding an opaque frame portion 16b having holes 16a formed therein, a transparent portion 16c, and an opaque portion 16d by two-color molding etc. The opaque portion 16d is provided at two positions in the vertical direction of the vehicle 1 so as to extend in the lateral direction of the vehicle 1. The transparent portion 16c is formed in a portion located between the frame portion 16b and each opaque portion 16d.

The light guiding member 17 is a transparent plate-like member made of a resin such as polymethylmethacrylate or polycarbonate. A first lens portion 17a is formed on a surface of the light guiding member 17 which faces the inside of the compartment, and a second lens portion 17b is formed on a surface of the light guiding member 17 which faces the outside of the compartment. The first lens portion 17a and the second lens portion 17b are not shown in FIG. 4(a).

As shown in FIG. 4(b), the lamp 15 is mounted by fixing with the screws 6f the frame portion 16b of the housing 16 to the support portion 4b provided on the surface 4a of the window member 4 which faces the inside of the compartment, thereby forming a window unit 13.

The plurality of LEDs 8 as the light source according to one or more embodiments of the present invention are arranged side-by-side in the lateral direction of the vehicle 1 on each opaque portion 16d of the housing 16. The light guiding member 17 is placed at a position closer to the outside of the compartment than the LEDs 8 in a space defined by the surface 4a of the window member 4 and the housing 16. At this time, each LED 8 is accommodated in the first lens portion 17a formed as a groove. The first lens portion 17a and the second lens portion 17b of the light guiding member 17 are arranged side-by-side from the inside toward the outside of the compartment on the optical axis of each LED 8.

The first lens portion 17a of the light guiding member 17 has a well-known shape that diffuse incident light in the vertical direction of the vehicle 1. The second lens portion 17b of the light guiding member 17 has a well-known shape that can diffuse incident light in the lateral direction of the vehicle 1 to emit the diffused light.

A total reflection surface 17c is formed on the side of the light guiding member 17 which faces the inside of the compartment. The total reflection surface 17c is formed at two positions in the vertical direction of the vehicle 1 so as to extend in the lateral direction of the vehicle 1. The total reflection surfaced 17c has a well-known shape that can reflect incident light toward the outside of the compartment. The light guiding member 17 is overall configured to guide light emitted from each LED 8 to the outside of the compartment.

Light emitted from each LED 8 is diffused by the first lens portion 17a, and travels inside the light guiding member 17. A part L1 of this light passes through the second lens portion 17b, whereby the light L1 passes through the window member 4 while being diffused in the lateral direction of the vehicle 1. Thus, light is visually recognized as being emitted from near the opaque portions 16d of the housing 6 as viewed from behind the vehicle 1.

Another part L2 of the light emitted from each LED 8 travels while being internally reflected in the light guiding member 17, and is finally reflected toward the outside of the compartment by the total reflection surface 17c and passes through the window member 4. Thus, light is visually recognized as being emitted from near the total reflection surface 17c of the light guiding member 17 as viewed from behind the vehicle 1.

As shown in FIG. 4(b), a region where the transparent portion 16c of the housing 16 is formed is a transparent part 19 that allows the occupant to see rearward (outside) of the vehicle from the inside of the compartment through the light guiding portion 17 and a part of the window member 4. This can ensure rear (outside) visibility of the vehicle although the lamp 15 functioning as a rear combination lamp is mounted so as to cover a part of the window member 4.

The opaque portion 16d of the housing 16 functions as the light shielding member according to one or more embodiments of the present invention, and blocks light emitted from each LED 8 and traveling toward the inside of the compartment. This can ensure rear (outside) visibility of the vehicle, and does not allow light of each LED 8 to be in the driver's sight when each LED 8 is lit, whereby his/her driving operation can be prevented from being hindered by such light.

The transparent portion 16c of the housing 16 in the present embodiment is colored so as to have characteristics that selectively absorb light having an emission wavelength of the LEDs 8. For example, in the case where the LEDs 8 emit red light, the transparent portion 16c is colored clear blue.

Since light emitted from each LED 8 is internally reflected by the light guiding member 17, leakage light may be caused at an unexpected location. The above configuration can reliably block such leakage light by the transparent portion 16c. This can avoid the disadvantage that is caused by the red light leaking to the front of the vehicle. Since the area of the opaque portion 16d need not be increased to prevent leakage light, rear (outside) visibility of the vehicle is not hindered.

The “characteristics that selectively absorb light having an emission wavelength” do not necessarily require having an absorption spectrum peak at this wavelength, but means having a significant selective light absorption property at this wavelength.

Since the transparent portion 16c functioning as a part of the transparent part and the opaque portion 16d functioning as the light-shielding member are molded integrally, the number of parts and the number of assembly steps can be reduced.

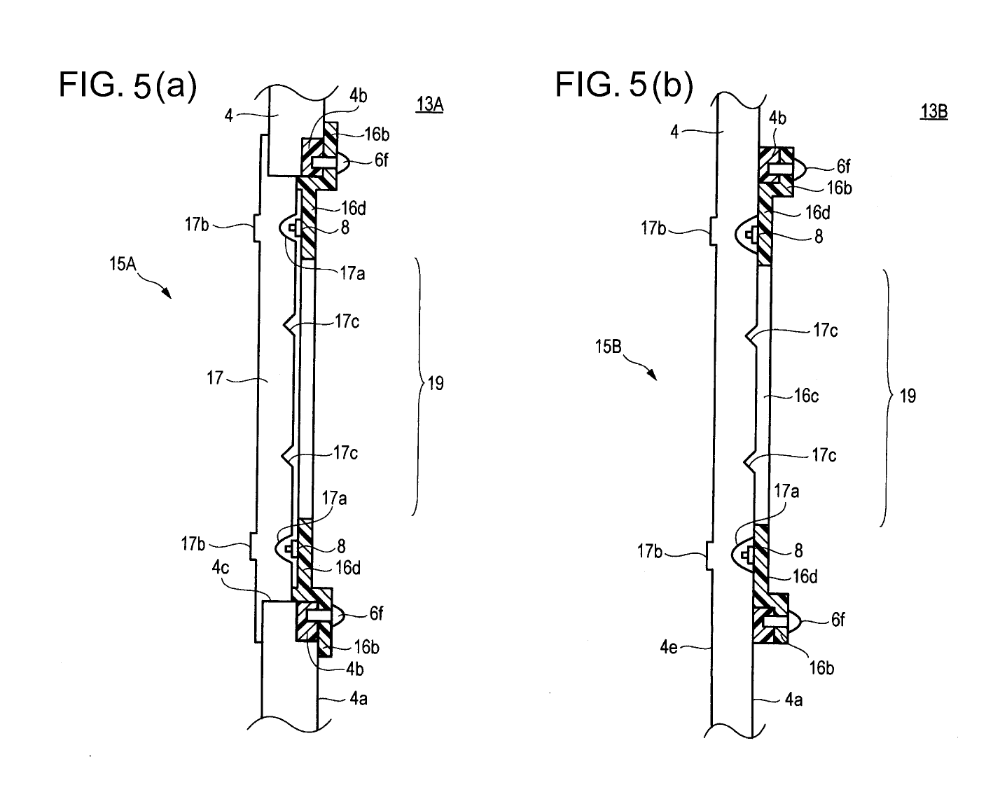

FIG. 5(a) is a longitudinal sectional view showing a first modification of the second embodiment. Those elements which have a similar function to the configuration shown in FIGS. 4(a)-4(b) are denoted with the same reference numerals, and repetitive description thereof will be omitted. A lamp 15A according to this modification is different from the lamp 15 and the window unit 13 shown in FIGS. 4(a)-4(b) in that a window unit 13A is formed by mounting the lamp 15A in the opening 4c formed in the window member 4. This configuration can reduce the dimensions of the lamp in the thickness direction.

FIG. 5(b) is a longitudinal sectional view showing a second modification of the first embodiment. Those elements which have a similar function to the configuration shown in FIGS. 4(a)-4(b) are denoted with the same reference numerals, and repetitive description thereof will be omitted. A lamp 15B according to this modification is different from the lamp 15 and the window unit 13 shown in FIGS. 4(a)-4(b) in that a window unit 13B is formed by using a part of the window member 4 as the light guiding member.

In this modification, the first lens member 17a is formed on a part of the surface 4a of the window member 4 which faces the inside of the compartment, and the second lens portion 17b is formed on a part of the surface 4e of the window member 4 which faces the outside of the compartment. The housing 16 is mounted on the window member 4 such that each LED 8 provided on the opaque portion 16d is accommodated in the first lens portion 17a forming a recess. This configuration can reduce the number of parts, and can reduce the dimensions of the lamp in the thickness direction.

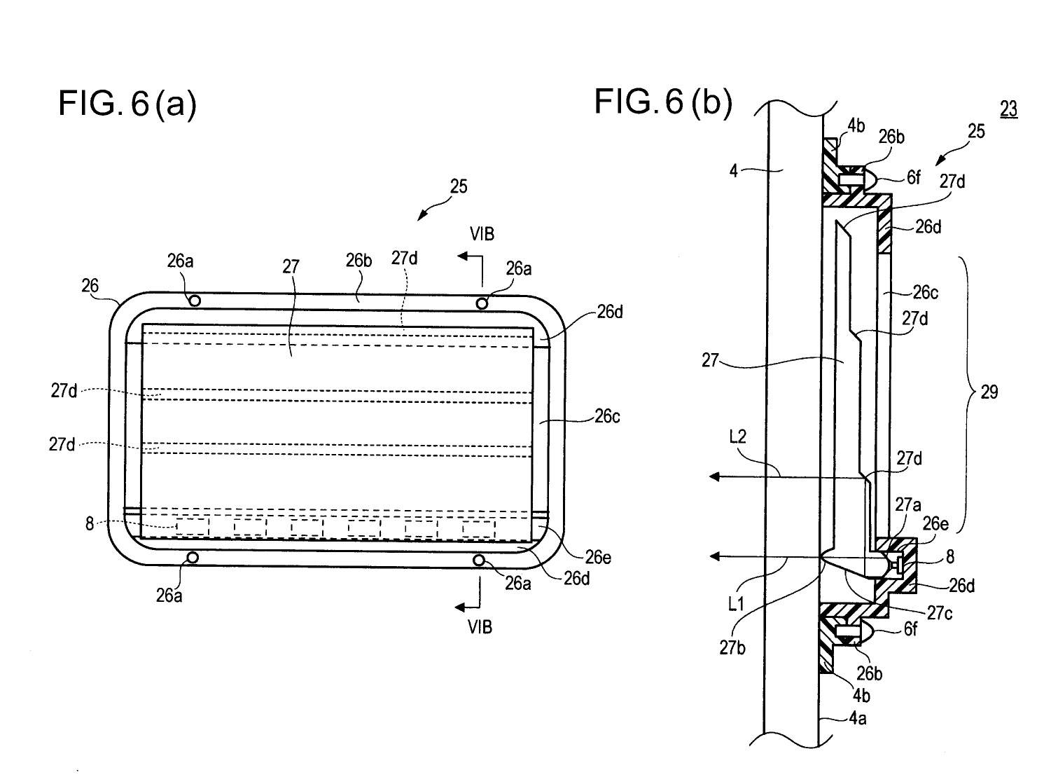

FIGS. 6(a)-6(b) schematically show the configuration of a lamp 25 according to a third embodiment of the present invention. FIG. 6(a) is a front view of the lamp 25 mounted on a vehicle as viewed from the rear, and FIG. 6(b) is a longitudinal sectional view taken along line VIB-VIB in FIG. 6(a). Those elements which have a similar function to the configuration shown in FIGS. 2(a)-2(b) are denoted with the same reference numerals, and repetitive description thereof will be omitted. The lamp 25 includes a housing 26, a light guiding member 27, and a plurality of LEDs 8.

The housing 26 is a resin member that is formed by integrally molding an opaque frame portion 26b having holes 26a formed therein, a transparent portion 26c, and an opaque portion 26d by two-color molding etc. The opaque portion 26d is provided at two positions in the vertical direction of the vehicle 1 so as to extend in the lateral direction of the vehicle 1. A groove 26e extending in the lateral direction of the vehicle 1 is formed in the opaque portion 26d located at the lower position. The transparent portion 26c is formed in a portion located between the frame portion 26b and each opaque portion 26d.

The light guiding member 27 is a transparent plate-like member made of a resin such as polymethylmethacrylate or polycarbonate. A first lens portion 27a is formed on a surface of the light guiding member 27 which faces the inside of the compartment, and a second lens portion 27b is formed on a surface of the light guiding member 17 which faces the outside of the compartment. The first lens portion 27a and the second lens portion 27b are not shown in FIG. 6(a).

As shown in FIG. 6(b), the lamp 25 is mounted by fixing with the screws 6f the frame portion 26b of the housing 26 to the support portion 4b provided on the surface 4a of the window member 4 which faces the inside of the compartment, thereby forming a window unit 23.

The plurality of LEDs 8 as the light source according to one or more embodiments of the present invention are arranged side-by-side in the lateral direction of the vehicle 1 in the groove 26e formed by the lower opaque portion 26d. The light guiding member 27 is placed at a position closer to the outside of the compartment than the LEDs 8 in a space defined by the surface 4a of the window member 4 and the housing 26. At this time, a part of the first lens portion 27a is accommodated in the groove 26e. The first lens portion 27a and the second lens portion 27b of the light guiding member 27 are arranged side-by-side from the inside toward the outside of the compartment near the optical axis of each LED 8.

The first lens portion 27a of the light guiding member 27 has a well-known shape that can form incident light into parallel light fluxes. The second lens portion 27b of the light guiding member 27 has a well-known shape that can diffuse incident light in the lateral direction of the vehicle 1 to emit the diffused light.

A total reflection surface 27c adjoining the second lens portion 27b is formed on the side of the light guiding member 27 which faces the outside of the compartment. A total reflection surface 27d is formed on the side of the light guiding member 27 which faces the inside of the compartment. The total reflection surface 27d is formed at three positions in the vertical direction of the vehicle 1 so as to extend in the lateral direction of the vehicle 1. The total reflection surfaced 27c has a well-known shape that can reflect incident light in the upward direction of the vehicle 1. The total reflection surface 27d has a well-known shape that can reflect incident light toward the outside of the compartment. The light guiding member 27 is overall configured to guide light emitted from each LED 8 to the outside of the compartment.

Light emitted from each LED 8 is formed into parallel light fluxes by the first lens portion 17a, and travels inside the light guiding member 17. A part L1 of this light passes through the second lens portion 17b, whereby the light fluxes L1 pass through the window member 4 while being diffused in the lateral direction of the vehicle 1. Thus, light is visually recognized as being emitted from near the opaque portions 26d of the housing 26 as viewed from behind the vehicle 1.

Another part L2 of the light emitted from each LED 8 is reflected by the total reflection surface 27c and travels inside the light guiding member 27, and is finally reflected toward the outside of the compartment by the total reflection surface 27d and passes through the window member 4. Thus, light is visually recognized as being emitted from near the total reflection surface 27d of the light guiding member 17 as viewed from behind the vehicle 1.

As shown in FIG. 6(b), a region where the transparent portion 26c of the housing 26 is formed is a transparent part 29 that allows the occupant to see rearward (outside) of the vehicle from the inside of the compartment through the light guiding portion 27 and a part of the window member 4. This can ensure rear (outside) visibility of the vehicle although the lamp 25 functioning as a rear combination lamp is mounted so as to cover a part of the window member 4.

The opaque portion 26d of the housing 26 functions as a light shielding member according to one or more embodiments of the present invention, and blocks light emitted from each LED 8 and traveling toward the inside of the compartment. This can ensure rear (outside) visibility of the vehicle, and does not allow light of each LED 8 to be in the driver's sight when each LED 8 is lit, whereby his/her driving operation can be prevented from being hindered by such light.

The transparent portion 26c of the housing 26 in the present embodiment is colored so as to have characteristics that selectively absorb light having an emission wavelength of the LEDs 8. For example, in the case where the LEDs 8 emit red light, the transparent portion 26c is colored clear blue.

Since light emitted from each LED 8 is internally reflected by the light guiding member 27, leakage light may be caused at an unexpected location. The above configuration can reliably block such leakage light by the transparent portion 26c. This can avoid the disadvantage that is caused by the red light leaking to the front of the vehicle. Since the area of the opaque portion 26d need not be increased to prevent leakage light, rear (outside) visibility of the vehicle is not hindered.

Since the transparent portion 26c functioning as a part of the transparent part and the opaque portion 26d functioning as the light-shielding member are molded integrally, the number of parts and the number of assembly steps can be reduced.

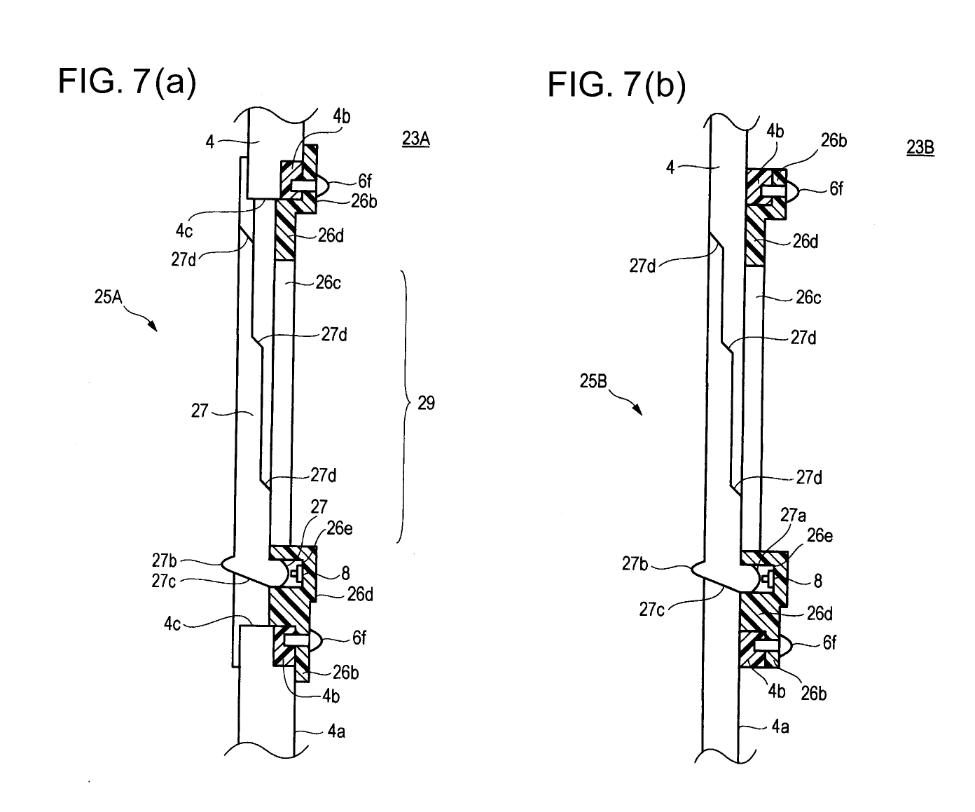

FIG. 7(a) is a longitudinal sectional view showing a first modification of the third embodiment. Those elements which have a similar function to the configuration shown in FIGS. 6(a)-6(b) are denoted with the same reference numerals, and repetitive description thereof will be omitted. A lamp 25A according to this modification is different from the lamp 25 and the window unit 23 shown in FIGS. 6(a)-6(b) in that a window unit 23A is formed by mounting the lamp 25A in the opening 4c formed in the window member 4. This configuration can reduce the dimensions of the lamp in the thickness direction.

FIG. 7(b) is a longitudinal sectional view showing a second modification of the third embodiment. Those elements which have a similar function to the configuration shown in FIGS. 6(a)-6(b) are denoted with the same reference numerals, and repetitive description thereof will be omitted. A lamp 25B according to this modification is different from the lamp 25 and the window unit 23 shown in FIGS. 6(a)-6(b) in that a window unit 23B is formed by using a part of the window member 4 as the light guiding member.

In this modification, the first lens member 27a and the total reflection surface 27d are formed on a part of the side of the window member 4 which faces the inside of the compartment, and the second lens portion 27b and the total reflection surface 27c are formed on a part of the side of the window member 4 which faces the outside of the compartment. The housing 26 is mounted on the window member 4 such that the first lens portion 27a is accommodated in the groove 26e formed in the opaque portion 26d. This configuration can reduce the number of parts, and can reduce the dimensions of the lamp in the thickness direction.

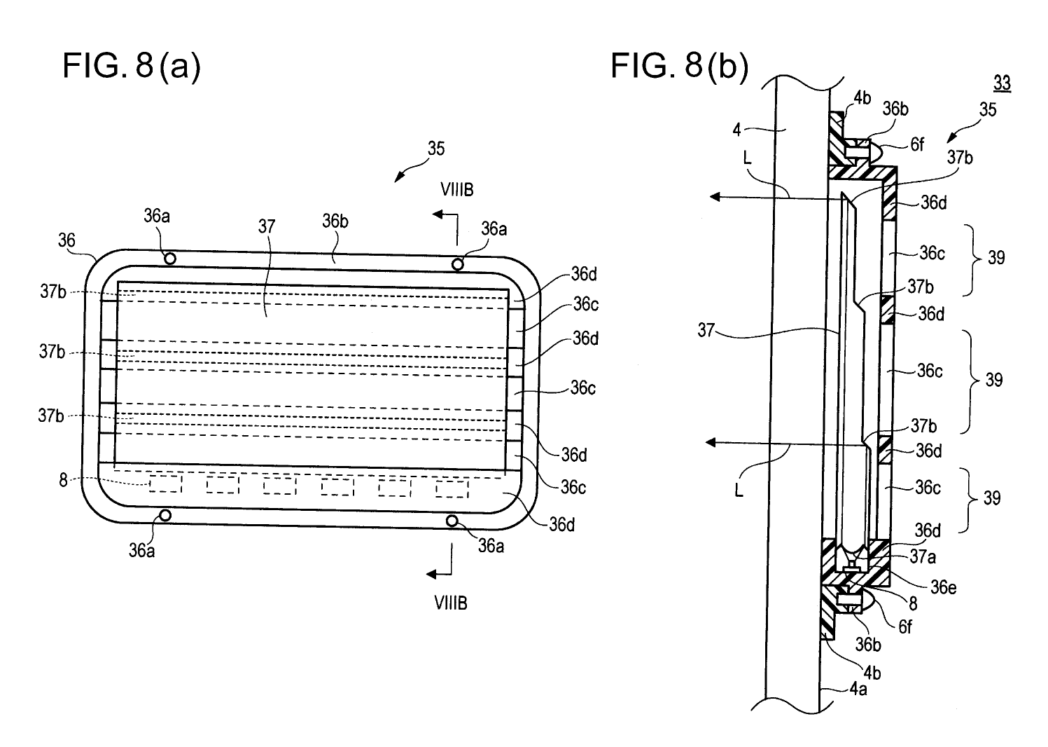

FIGS. 8(a)-8(b) schematically shows the configuration of a lamp 35 according to a fourth embodiment of the present invention. FIG. 8(a) is a front view of the lamp 35 mounted on a vehicle as viewed from the rear, and FIG. 8(b) is a longitudinal sectional view taken along line VIIIB-VIIIB in FIG. 8(a). Those elements which have a similar function to the configuration shown in FIGS. 2(a)-2(b) are denoted with the same reference numerals, and repetitive description thereof will be omitted. The lamp 35 includes a housing 36, a light guiding member 37, and a plurality of LEDs 8.

The housing 36 is a resin member that is formed by integrally molding an opaque frame portion 36b having holes 36a formed therein, a transparent portion 36c, and an opaque portion 36d by two-color molding etc. The opaque portion 36d is provided at four positions in the vertical direction of the vehicle 1 so as to extend in the lateral direction of the vehicle 1. A groove 36e extending in the lateral direction of the vehicle 1 and opening upward is formed in the opaque portion 36d located at the lowest position. The transparent portion 36c is formed in a portion located between the frame portion 36b and each opaque portion 36d.

The light guiding member 37 is a transparent plate-like member made of a resin such as polymethylmethacrylate or polycarbonate. A first lens portion 37a is formed on a surface of the light guiding member 37 which faces downward when mounted on the vehicle. The first lens portion 37a has a well-known shape that can form incident light into parallel light fluxes.

As shown in FIG. 8(b), the lamp 35 is mounted by fixing with the screws 6f the frame portion 36b of the housing 36 to the support portion 4b provided on the surface 4a of the window member 4 which faces the inside of the compartment, thereby forming a window unit 33.

The plurality of LEDs 8 as the light source according to one or more embodiments of the present invention are arranged side-by-side in the lateral direction of the vehicle 1 in the groove 36e formed by the opaque portion 36d of the housing 36. The light guiding member 37 is placed above the LEDs 8 in a space defined by the surface 4a of the window member 4 and the housing 36. At this time, a part of the first lens portion 37a is accommodated in the groove 36e formed in the opaque portion 36d of the housing 36. The first lens portion 37a of the light guiding member 37 is placed on the optical axis of each LED 8.

A total reflection surface 37b is formed on the side of the light guiding member 37 which faces the inside of the compartment. The total reflection surface 37b is formed at three positions in the vertical direction of the vehicle 1 so as to extend in the lateral direction of the vehicle 1. The total reflection surfaced 37b has a well-known shape that can reflect incident light toward the outside of the compartment. The light guiding member 37 is overall configured to guide light emitted from each LED 8 to the outside of the compartment.

Light L emitted from each LED 8 is formed into parallel light fluxes by the first lens portion 37a, travels inside the light guiding member 37, is reflected toward the outside of the compartment by the total reflection surface 37b, and passes through the window member 4. Thus, light is visually recognized as being emitted from near the total reflection surface 37b of the light guiding member 37 as viewed from behind the vehicle 1.

As shown in FIG. 8(b), a region where the transparent portion 36c of the housing 36 is formed is a transparent part 39 that allows the occupant to see rearward (outside) of the vehicle from the inside of the compartment through the light guiding portion 37 and a part of the window member 4. This can ensure rear (outside) visibility of the vehicle although the lamp 35 functioning as a rear combination lamp is mounted so as to cover a part of the window member 4.

The opaque portion 36d of the housing 6 functions as the light shielding member according to one or more embodiments of the present invention, and blocks light emitted from each LED 8 and traveling toward the inside of the compartment. This can ensure rear (outside) visibility of the vehicle, and does not allow light of each LED 8 to be in the driver's sight when each LED 8 is lit, whereby his/her driving operation can be prevented from being hindered by such light. Moreover, the disadvantage that is caused by the red light leaking to the front of the vehicle can be avoided.

Since the transparent portion 36c functioning as a part of the transparent part and the opaque portion 36d functioning as the light-shielding member are molded integrally, the number of parts and the number of assembly steps can be reduced.

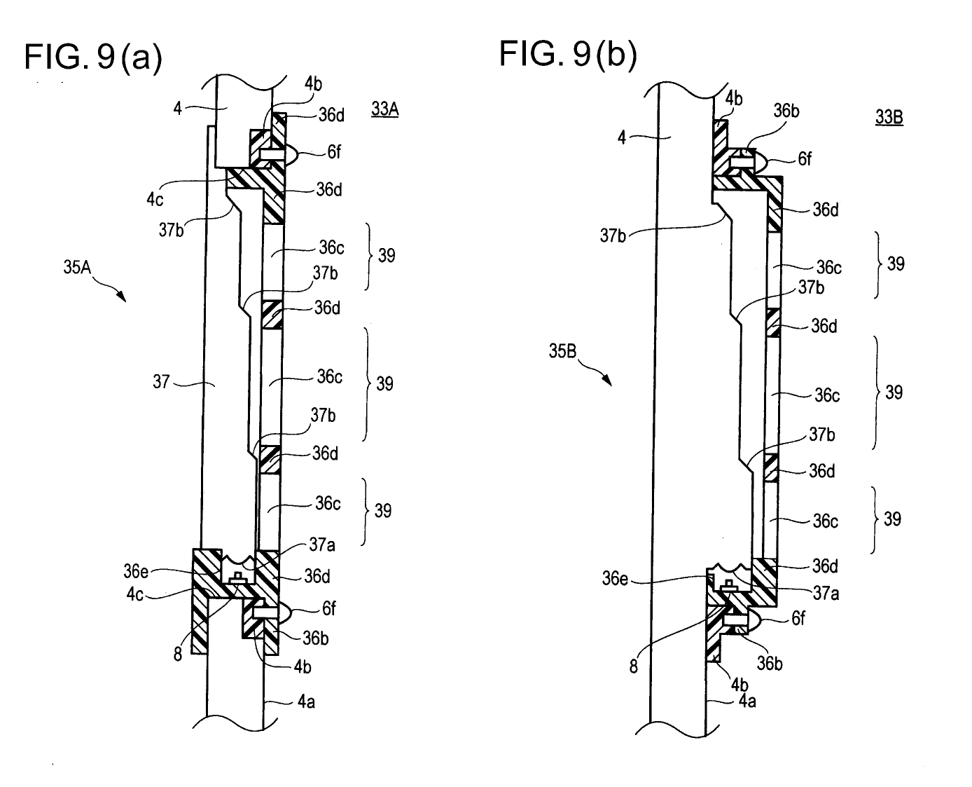

FIG. 9(a) is a longitudinal sectional view showing a first modification of the fourth embodiment. Those elements which have a similar function to the configuration shown in FIGS. 8(a)-8(b) are denoted with the same reference numerals, and repetitive description thereof will be omitted. A lamp 35A according to this modification is different from the lamp 35 and the window unit 33 shown in FIGS. 8(a)-8(b) in that a window unit 33A is formed by mounting the lamp 35A in the opening 4c formed in the window member 4. This configuration can reduce the dimensions of the lamp in the thickness direction.

FIG. 9(b) is a longitudinal sectional view showing a second modification of the fourth embodiment. Those elements which have a similar function to the configuration shown in FIGS. 8(a)-8(b) are denoted with the same reference numerals, and repetitive description thereof will be omitted. A lamp 35B according to this modification is different from the lamp 35 and the window unit 33 shown in FIGS. 8(a)-8(b) in that a window unit 33B is formed by using a part of the window member 4 as the light guiding member.

In this modification, the first lens member 37a and the total reflection surface 37d are formed on a part of the surface 4a of the window member 4 which faces the inside of the compartment. The housing 36 is mounted on the window member 4 such that the first lens portion 37a is accommodated in the groove 36e formed in the opaque portion 36d. This configuration can reduce the number of parts, and can reduce the dimensions of the lamp in the thickness direction.

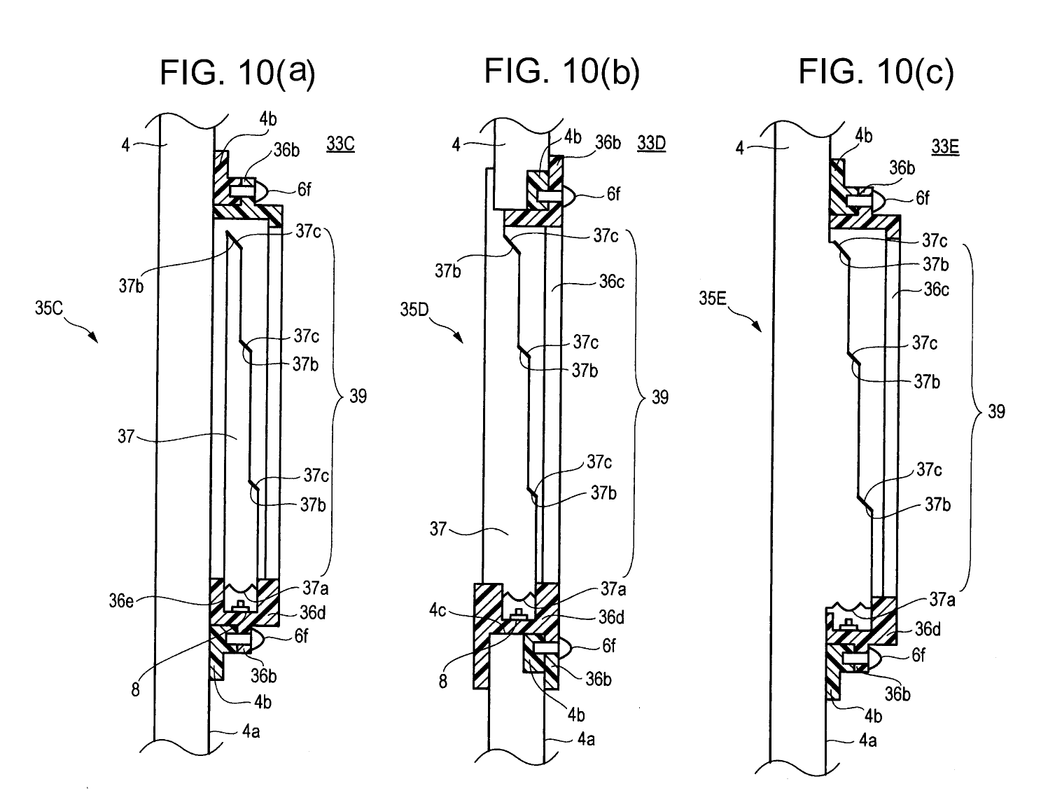

FIG. 10(a) is a longitudinal sectional view showing a third modification of the fourth embodiment. Those elements which have a similar function to the configuration shown in FIGS. 6(a)-6(b) are denoted with the same reference numerals, and repetitive description thereof will be omitted. A lamp 35C and a window unit 33C according to this modification are different from the lamp 35 and the window unit 33 shown in FIGS. 8(a)-8(b) in that an aluminized surface 37c is formed on the outer surface of each portion of the light guiding portion 37 where the total reflection surface 37c is formed. This configuration can reduce the dimensions of the lamp in the thickness direction.

The aluminized surface 37c functions as the light shielding member according to one or more embodiments of the present invention, and blocks light emitted from each LED 8 and traveling toward the inside of the compartment. Accordingly, only the opaque portion 36d of the housing 36 which is located at the lowest position and accommodates the LEDs 8 is provided. This configuration can minimize the area of a portion associated with blocking light, and can increase the area of the transparent portion 36c of the housing 36 as much as possible. This improves rear (outside) visibility of the vehicle through the transparent part 39.

FIG. 10(b) is a longitudinal sectional view showing a fourth modification of the fourth embodiment. Those elements which have a similar function to the configuration shown in FIG. 10(a) are denoted with the same reference numerals, and repetitive description thereof will be omitted. A lamp 35D according to this modification is different from the lamp 35C and the window unit 33C shown in FIG. 10(a) in that a window unit 33D is formed by mounting the lamp 35D in the opening 4c formed in the window member 4. This configuration can reduce the dimensions of the lamp in the thickness direction.

FIG. 10(b) is a longitudinal sectional view showing a fifth modification of the fourth embodiment. Those elements which have a similar function to the configuration shown in FIG. 10(a) are denoted with the same reference numerals, and repetitive description thereof will be omitted. A lamp 35E according to this modification is different from the lamp 35C and the window unit 33C shown in FIG. 10(a) in that a window unit 33E is formed by using a part of the window member 4 as the light guiding member. This configuration can reduce the number of parts, and can reduce the dimensions of the lamp in the thickness direction.

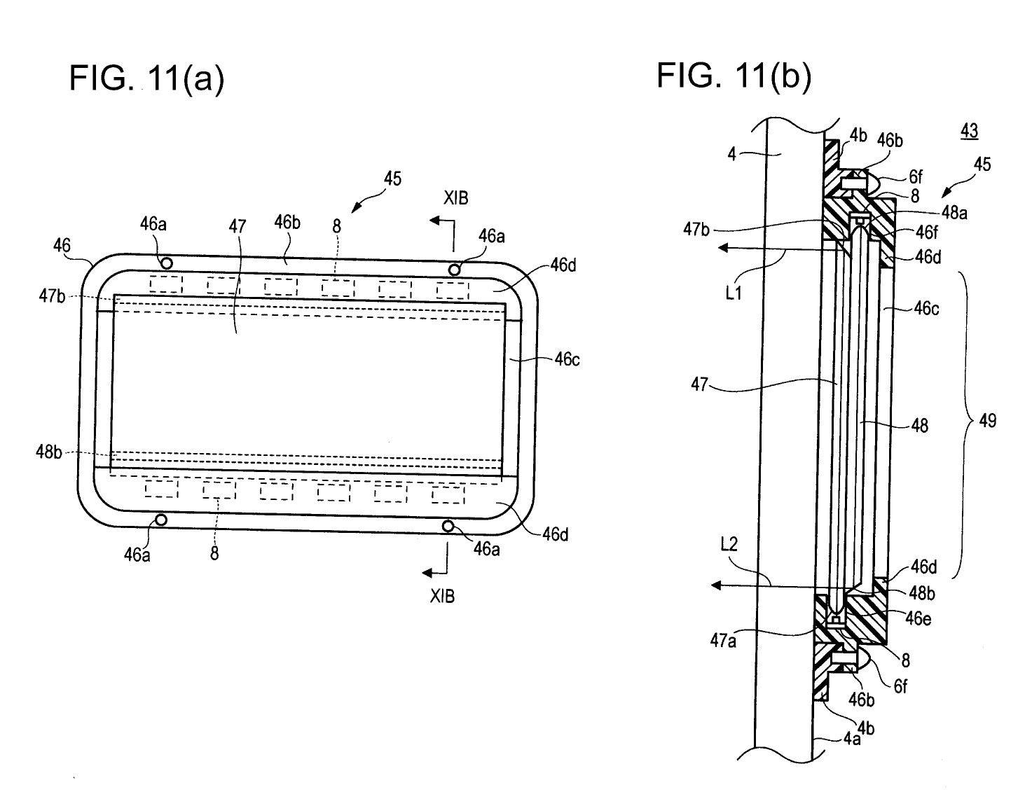

FIGS. 11(a)-11(b) schematically show the configuration of a lamp 45 according to a fifth embodiment of the present invention. FIG. 11(a) is a front view of the lamp 45 mounted on a vehicle as viewed from the rear, and FIG. 11(b) is a longitudinal sectional view taken along line XIB-XIB in FIG. 11(a). Those elements which have a similar function to the configuration shown in FIGS. 2(a)-2(b) are denoted with the same reference numerals, and repetitive description thereof will be omitted. The lamp 45 includes a housing 46, a light guiding member 47, a light guiding member 48, and a plurality of LEDs 8.

The housing 46 is a resin member that is formed by integrally molding an opaque frame portion 46b having holes 46a formed therein, a transparent portion 46c, and an opaque portion 46d by two-color molding etc. The opaque portion 46d is provided at two positions in the vertical direction of the vehicle 1 so as to extend in the lateral direction of the vehicle 1. A groove 46e extending in the lateral direction of the vehicle 1 and opening upward is formed in the opaque portion 46d located at the lower position. A groove 46f extending in the lateral direction of the vehicle 1 and opening downward is formed in the opaque portion 46d located at the upper position. The transparent portion 46c is formed in a portion located between the frame portion 46b and each opaque portion 46d.

The light guiding member 47 is a transparent plate-like member made of a resin such as polymethylmethacrylate or polycarbonate. A first lens portion 47a is formed on a surface of the light guiding member 47 which faces downward when mounted on the vehicle. The first lens portion 47a has a well-known shape that can form incident light into parallel light fluxes.

The light guiding member 48 is a transparent plate-like member made of a resin such as polymethylmethacrylate or polycarbonate. A first lens portion 48a is formed on a surface of the light guiding member 48 which faces upward when mounted on the vehicle. The first lens portion 48a has a well-known shape that can form incident light into parallel light fluxes.

As shown in FIG. 11(b), the lamp 45 is mounted by fixing with the screws 6f the frame portion 46b of the housing 46 to the support portion 4b provided on the surface 4a of the window member 4 which faces the inside of the compartment, thereby forming a window unit 43.

The plurality of LEDs 8 as the light source according to one or more embodiments of the present invention are arranged side-by-side in the lateral direction of the vehicle 1 in the grooves 46e, 46f formed by the opaque portions 46d of the housing 46. The light guiding member 47 is placed at a position closer to the outside of the compartment than the light guiding member 48 in a space defined by the surface 4a of the window member 4 and the housing 46. At this time, the light guiding member 47 is placed above the LEDs 8 arranged in the groove 46e, and a part of the first lens 47a is accommodated in the groove 46e. The light guiding member 48 is placed below the LEDs 8 arranged in the groove 46f, and a part of the first lens 48a is accommodated in the groove 46f. Each of the first lens portions 47a, 48a is placed on the optical axis of each LED 8.

A total reflection surface 47b is formed on the upper end of the light guiding member 47 so as to extend in the lateral direction of the vehicle 1. The total reflection surface 47b has a well-known shape that can reflect incident light toward the outside of the compartment. The light guiding member 47 is overall configured to guide light emitted from the LEDs 8 arranged in the groove 46e to the outside of the compartment.

A total reflection surface 48b is formed on the lower end of the light guiding member 48 so as to extend in the lateral direction of the vehicle 1. The total reflection surface 48b has a well-known shape that can reflect incident light toward the outside of the compartment. The light guiding member 48 is overall configured to guide light emitted from the LEDs 8 arranged in the groove 46f to the outside of the compartment.

Light L1 emitted from the LEDs 8 arranged in the groove 46e is formed into parallel light fluxes by the first lens portion 47a, travels inside the light guiding member 47, is reflected toward the outside of the compartment by the total reflection surface 47b, and passes through the window member 4. Thus, light is visually recognized as being emitted from near the total reflection surface 47b of the light guiding member 47 as viewed from behind the vehicle 1.

Light L2 emitted from the LEDs 8 arranged in the groove 46f is formed into parallel light fluxes by the first lens portion 48a, travels inside the light guiding member 48, is reflected toward the outside of the compartment by the total reflection surface 48b, and passes through the window member 4. Thus, light is visually recognized as being emitted from near the total reflection surface 48b of the light guiding member 48 as viewed from behind the vehicle 1.

As shown in FIG. 11(b), a region where the transparent portion 46c of the housing 46 is formed is a transparent part 49 that allows the occupant to see rearward (outside) of the vehicle from the inside of the compartment through each light guiding portion 47, 48 and a part of the window member 4. This can ensure rear (outside) visibility of the vehicle although the lamp 45 functioning as a rear combination lamp is mounted so as to cover a part of the window member 4.

The opaque portion 46d of the housing 46 functions as the light shielding member according to one or more embodiments of the present invention, and blocks light emitted from each LED 8 and traveling toward the inside of the compartment. This can ensure rear (outside) visibility of the vehicle, and does not allow light of each LED 8 to be in the driver's sight when each LED 8 is lit, whereby his/her driving operation can be prevented from being hindered by such light. Moreover, the disadvantage that is caused by the red light leaking to the front of the vehicle can be avoided.

Since the transparent portion 46c functioning as a part of the transparent part and the opaque portion 46d functioning as the light-shielding member are molded integrally, the number of parts and the number of assembly steps can be reduced.

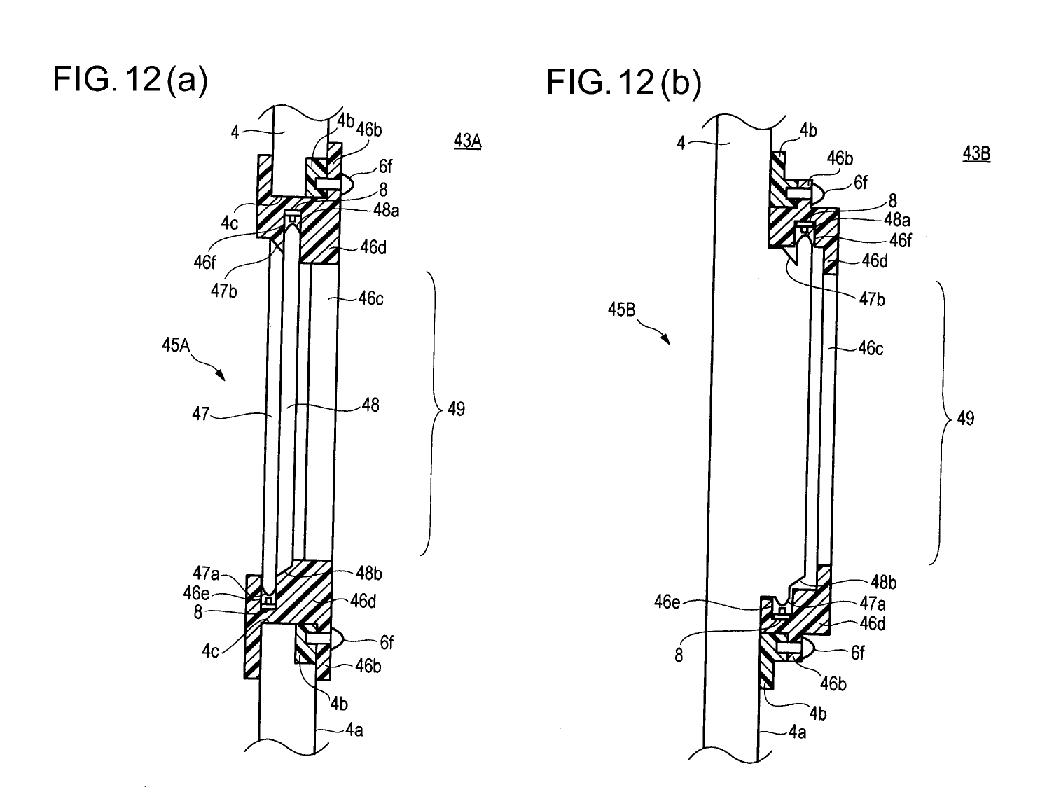

FIG. 12(a) is a longitudinal sectional view showing a first modification of the fifth embodiment. Those elements which have a similar function to the configuration shown in FIGS. 11(a)-11(b) are denoted with the same reference numerals, and repetitive description thereof will be omitted. A lamp 45A according to this modification is different from the lamp 45 and the window unit 43 shown in FIGS. 11(a)-11(b) in that a window unit 43A is formed by mounting the lamp 45A in the opening 4c formed in the window member 4. This configuration can reduce the dimensions of the lamp in the thickness direction.

FIG. 12(b) is a longitudinal sectional view showing a second modification of the fifth embodiment. Those elements which have a similar function to the configuration shown in FIGS. 11(a)-11(b) are denoted with the same reference numerals, and repetitive description thereof will be omitted. A lamp 45B according to this modification is different from the lamp 45 and the window unit 43 shown in FIGS. 11(a)-11(b) in that a window unit 43B is formed by using a part of the window member 4 as the light guiding member.

In this modification, the first lens members 47a, 48a and the total reflection surfaces 47d, 48b are formed on a part of the surface 4a of the window member 4 which faces the inside of the compartment. The housing 46 is mounted on the window member 4 such that the first lens portion 47a is accommodated in the groove 46e formed in the lower opaque portion 46d, and that the first lens portion 48a is accommodated in the groove 46f formed in the upper opaque portion 46d. This configuration can reduce the number of parts, and can reduce the dimensions of the lamp in the thickness direction.

As can be seen from this modification, the light guiding member 47 and the light guiding member 48 may be an integrally molded optical part.

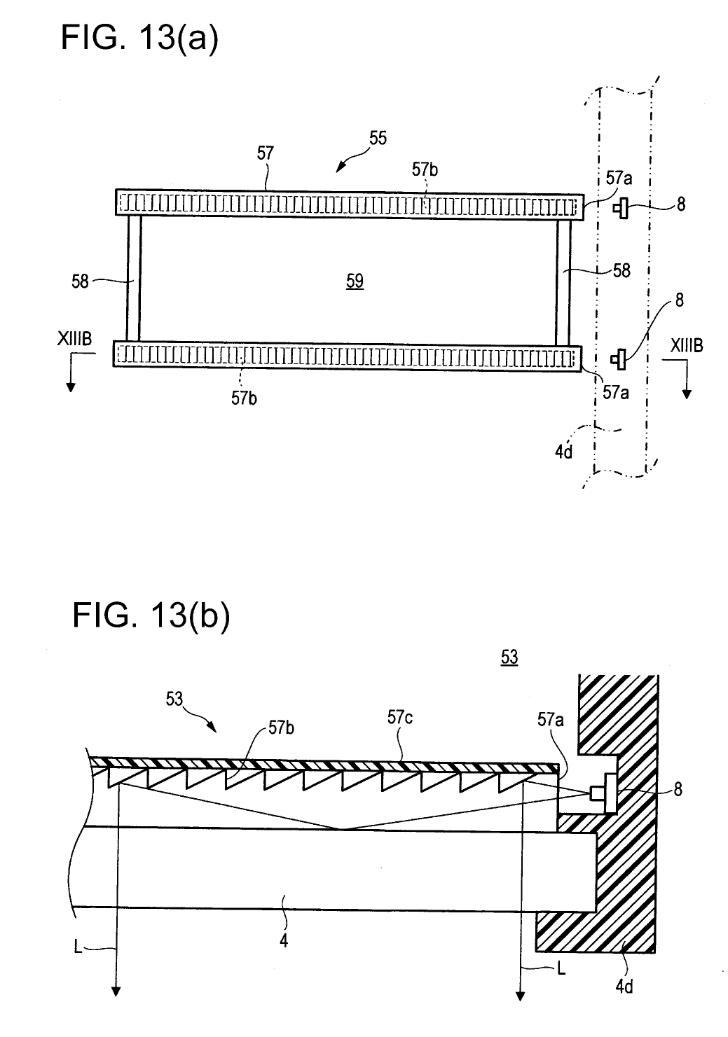

FIGS. 4(a)-4(b) schematically show the configuration of a lamp 55 according to a sixth embodiment of the present invention. FIG. 13(a) is a front view of the lamp 55 mounted on a vehicle as viewed from the rear, and FIG. 13(b) is a partial enlarged transverse sectional view taken along line XIIIB-XIIIB in FIG. 13(a). Those elements which have a similar function to the configuration shown in FIGS. 2(a)-2(b) are denoted with the same reference numerals, and repetitive description thereof will be omitted. The lamp 55 includes two light guiding members 57, two coupling members 58, and two LEDs 8. The respective numbers of these elements are determined as appropriate according to the specification of the vehicle 1 on which the lamp 55 is to be mounted, and the purpose of using the lamp 55.

Each light guiding member 57 is a transparent bar-like member made of a resin such as polymethylmethacrylate or polycarbonate. As shown in FIG. 13(b), the light guiding member 57 is mounted on the surface 4a of the window member 4 which faces the inside of the compartment, and extends in the lateral direction of the vehicle. The coupling member 58 couples the two light guiding members 57 to each other, and is formed integrally with the light guiding members 57 by injection molding etc. This configuration can reduce the number of parts, and facilitates attachment to the window member 4.

Each of the LEDs 8 as the light source according to one or more embodiments of the present invention is placed so as to face one end surface 57a of a corresponding one of the light guiding members 57 in a space formed in the inside of the compartment in an opaque frame member 4d holding the window member 4 on the vehicle 1.

A plurality of steps 57b functioning as a reflecting surface are arranged on the side of each light guiding member 57 which faces the inside of the compartment, along the direction in which the light guiding member 57 extend. Light L emitted from the LED 8 and incident from the end surface 57a travels in the light guiding member 57, and is reflected toward the outside of the compartment by the steps 57b. The light emitted from the light guiding member 57 passes through the window member 4, and thus is visually recognized as being emitted from the entire light guiding member 57 as viewed from behind the vehicle 1.

A unidirectional translucent film 57c is provided on a surface of each light guiding member 57 which faces the inside of the compartment. The unidirectional translucent film 57c has characteristics that transmit therethrough light traveling from the inside toward the outside of the compartment, and that selectively absorb light traveling from the outside toward the inside of the compartment and having the emission wavelength of the LED 8.

Since light emitted from each LED 8 is internally reflected by the light guiding member 57, leakage light may be caused at an unexpected location. The above configuration can reliably block such leakage light by the unidirectional translucent film 57c. This can avoid the disadvantage that is caused by the red light leaking to the front of the vehicle.

Since the light traveling from the inside toward the outside of the compartment is transmitted through the unidirectional translucent film 57c, the light guiding member 57 is visually recognized as being transparent when the LED 8 is unlit, as viewed from the outside of the vehicle 1. Thus, the lamp 55 can provide novel appearance in which the lamp 55 covers a part of the window member 4 but is not recognized so much from the outside when the lamp is unlit.

The “characteristics that selectively absorb light having the emission wavelength” do not necessarily require having an absorption spectrum peak at this wavelength, but means having a significant selective light absorption property at this wavelength.

As shown in FIG. 13(a), a region located between the light guiding members 57 is a transparent part 59 that allows the occupant to see rearward (outside) of the vehicle from the inside of the compartment through a part of the window member 4. This can ensure rear (outside) visibility of the vehicle although the lamp 55 functioning as a rear combination lamp is mounted so as to cover a part of the window member 4.

In the present embodiment, the frame member 4d provided on the peripheral edge of the window member 4 functions as the light-shielding member according to one or more embodiments of the present invention. That is, light emitted from each LED 8 and traveling toward the inside of the compartment is also blocked by the frame member 4d. Since a part of the frame member 4d (see FIG. 1) required as a part forming a part of the vehicle is used as the light-shielding member, the number of parts can be reduced, and reduction in size and weight of the lamp can be implemented.

The above embodiments are provided to facilitate understanding of the present invention, and are not intended to limit the present invention. It should be understood that the present invention can be modified or improved without departing from the spirit and scope of the invention, and include equivalents thereof.

Semiconductor light-emitting elements used as a light source are not limited to the LEDs, but may be various solid-state light-emitting elements such as laser diodes, organic EL light-emitting elements, or inorganic EL light-emitting elements. The light source is not limited to these solid-state light-emitting elements, and may be well-known lamp light sources.

In the lamp 5 according to the first embodiment shown in FIGS. 2(a)-2(b), the frame portion 6b of the housing 6 need not necessarily be fixed to the support portion 4b of the window member 4 with the screws 6f. Both the frame portion 6b and the support portion 4b may be made of a resin, and may be fixed together by thermal welding. The same applies to the other embodiments.

Like the transparent portion 16c of the housing 16 in the lamp 15 according to the second embodiment shown in FIGS. 4(a)-4(b) and 5(a)-5(b), the transparent portion 6c of the housing 6 in the lamp 5 according to the first embodiment shown in FIGS. 2(a)-2(b) and 3(a)-3(b) may be colored so as to have characteristics that selectively absorb light having the emission wavelength of the LEDs 8. Alternatively, like the conductive member 57 in the lamp 55 according to the sixth embodiment shown in FIGS. 13(a)-13(b), a unidirectional translucent film having characteristics that selectively absorb light having the emission wavelength of the LEDs 8 may be provided on the surface of the transparent portion 6c which faces the inside of the compartment.

Like the conductive member 57 in the lamp 55 according to the sixth embodiment shown in FIGS. 13(a)-13(b), the housing 16 in the lamp 15 according to the second embodiment shown in FIGS. 4(a)-4(b) and 5(a)-5(b) may be configured so that a unidirectional translucent film having characteristics that selectively absorb light having the emission wavelength of the LEDs 8 is provided on the surface of the transparent portion 16c which faces the inside of the compartment.

Like the conductive member 57 in the lamp 55 according to the sixth embodiment shown in FIGS. 13(a)-13(b), the housing 26 in the lamp 25 according to the third embodiment shown in FIGS. 6(a)-6(b) and 7(a)-7(b) may be configured so that a unidirectional translucent film having characteristics that selectively absorb light having the emission wavelength of the LEDs 8 is provided on the surface of the transparent portion 26c which faces the inside of the compartment.

Like the transparent portion 16c of the housing 16 in the lamp 15 according to the second embodiment shown in FIGS. 4(a)-4(b) and 5(a)-5(b), the transparent portion 36c of the housing 36 in the lamp 35 according to the fourth embodiment shown in FIGS. 8(a) to 10(c) may be colored so as to have characteristics that selectively absorb light having the emission wavelength of the LEDs 8. Alternatively, like the conductive member 57 in the lamp 55 according to the sixth embodiment shown in FIGS. 13(a)-13(b), a unidirectional translucent film having characteristics that selectively absorb light having the emission wavelength of the LEDs 8 may be provided on the surface of the transparent portion 36c which faces the inside of the compartment.

Like the transparent portion 16c of the housing 16 in the lamp 15 according to the second embodiment shown in FIGS. 4(a)-4(b) and 5(a)-5(b), the transparent portion 46c of the housing 46 in the lamp 5 according to the fifth embodiment shown in FIGS. 11(a)-11(b) and 12(a)-12(b) may be colored so as to have characteristics that selectively absorb light having the emission wavelength of the LEDs 8. Alternatively, like the conductive member 57 in the lamp 55 according to the sixth embodiment shown in FIGS. 13(a)-13(b), a unidirectional translucent film having characteristics that selectively absorb light having the emission wavelength of the LEDs 8 may be provided on the surface of the transparent portion 46c which faces the inside of the compartment.

Like the lamp 55 according to the sixth embodiment shown in FIGS. 13(a)-13(b), the lamp 35 according to the fourth embodiment shown in FIGS. 8(a) to 10(c) may be configured so that each LED 8 is placed in a space formed in the inside of the compartment in the frame member 4d provided on the peripheral edge of the window member 4 and the frame member 4d functions as the light-shielding member.

Like the lamp 55 according to the sixth embodiment shown in FIGS. 13(a)-13(b), the lamp 45 according to the fifth embodiment shown in FIGS. 11(a)-11(b) and 12(a)-12(b) may be configured so that the LEDs 8 are arranged in a space formed in the inside of the compartment in the frame member 4d provided on the peripheral edge of the window member 4 and the frame member 4d functions as the light-shielding member.

As in the modification of the fourth embodiment shown in FIGS. 10(a)-10(c), the light guiding member 17 in the lamp 15 according to the second embodiment shown in FIGS. 4(a)-4(b) and 5(a)-5(b) may be configured so that an aluminized surface is formed on the outer surface of the portion where the total reflection surface 17c is formed.

As in the modification of the fourth embodiment shown in FIGS. 10(a)-10(c), the light guiding member 27 in the lamp 25 according to the third embodiment shown in FIGS. 6(a)-6(b) and 7(a)-7(b) may be configured so that an aluminized surface is formed on the outer surface of the portion where the total reflection surface 27d is formed.

The respective numbers of light guiding members 57 and coupling members 58 according to the sixth embodiment shown in FIGS. 13(a)-13(b) are not limited to two as shown in the figure, and may be one, or three or more. The respective numbers of light guiding members 57 and coupling members 58 and the arrangement thereof are selected as appropriate according to the specification of the vehicle 1 on which the lamp 55 is to be mounted.

The lamp according to one or more embodiments of the present invention is not limited to the applications of the rear combination lamp. The usage of the lamp, and the window member 4 on which the lamp is to be mounted are selected as appropriate according to the specification of the vehicle 1, as long as the lamp includes the transparent part that is transparent as viewed from the inside of the compartment, the light guiding member that guides light emitted from the light source toward the outside of the compartment, and the light-shielding member that blocks the light emitted from the light source and traveling toward the inside of the compartment.

### DESCRIPTION OF THE REFERENCE NUMERALS

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.
1 VEHICLE
3 WINDOW UNIT
4 WINDOW MEMBER
4d FRAME MEMBER
6c TRANSPARENT PORTION OF HOUSING
6d OPAQUE PORTION OF HOUSING
7 LIGHT GUIDING MEMBER
8 LED
9 TRANSPARENT PART
37c ALUMINIZED SURFACE

What is claimed is:

1. A vehicular lamp that is mounted on a vehicle, comprising:
a light source;
a transparent part that is transparent when viewed from inside of a compartment when mounted on the vehicle;
a light guiding member that forms at least a part of the transparent part, wherein the light guide member is configured to guide light emitted from the light source toward outside of the compartment when mounted on the vehicle; and
a light-shielding member that blocks the light emitted from the light source and that travels toward the inside of the compartment when mounted on the vehicle.

2. The vehicular lamp according to claim 1, wherein the at least a part of the transparent part is configured to selectively absorb light having an emission wavelength of the light source.

3. The vehicular lamp according to claim 1, wherein the at least a part of the transparent part and the light-shielding member are molded integrally.

4. The vehicular lamp according to claim 1, wherein the light-shielding member is formed on the light guiding member by evaporation.

5. A window unit that is provided on a vehicle, comprising:
a window member;
a light source;
a transparent part that is transparent when viewed from inside of the window member;
a light guiding member that forms at least a part of the transparent part, wherein the light guide member is configured to guide light emitted from the light source toward outside of the window member; and
a light-shielding member that blocks the light emitted from the light source and that travels toward the inside of the window member.

6. The window unit according to claim 5, wherein the at least a part of the transparent part has characteristics that selectively absorb light having an emission wavelength of the light source.

7. The window unit according to claim 5, wherein the light guiding member is molded integrally with the window member.

8. The window unit according to claim 5, further comprising:
an opaque frame member provided on a peripheral edge of the window member,
wherein a part of the light-shielding member is formed by the frame member.

9. The vehicular lamp according to claim 2, wherein the at least a part of the transparent part and the light-shielding member are molded integrally.

10. The vehicular lamp according to claim 2, wherein the light-shielding member is formed on the light guiding member by evaporation.

11. The vehicular lamp according to claim 3, wherein the light-shielding member is formed on the light guiding member by evaporation.

12. The window unit according to claim 6, wherein the light guiding member is molded integrally with the window member.

13. The window unit according to claim 6, further comprising:
an opaque frame member provided on a peripheral edge of the window member,
wherein a part of the light-shielding member is formed by the frame member.

14. The window unit according to claim 7, further comprising:
an opaque frame member provided on a peripheral edge of the window member,
wherein a part of the light-shielding member is formed by the frame member.
